(19) United States
(12) Patent Application Publication
(10) Pub. No.: US 2005/0129227 A1
(43) Pub. Date: Jun. 16, 2005

(54) Method for testing subscriber connection lines for broadband services

(76) Inventors: Thomas Ahrndt, Ottobrunn (DE); Werner Kozek, Wien (AT); Bert Schuszler, Wien (AT)

Correspondence Address: Intellectual Property Departement, 170 Wood Avenue South, Iselin, NJ, 08830, US

(21) Appl. No.: 10/511,021

(22) PCT Filed: Apr. 15, 2003
(86) PCT No.: PCT/EP03/03930

(30) Foreign Application Priority Data
Apr. 16, 2002 (EP) 02008552.8

(51) Int. Cl. H04M 9/08

(52) U.S. Cl. 379/406.13; 379/406.01

(57) ABSTRACT

The invention relates to a method for pre-qualifying subscriber connection lines for broadband services. According to said method, a mathematical characterisation of the physical behaviour of the subscriber connection line is obtained by applying a signal to the subscriber connection line to be tested and the output signal is then observed. Conclusions concerning relevant parameters of the subscriber connection line are inferred from said mathematical characterisation with the help of a classical physical models. A combined time-frequency representation, the Weil transformation according to “A. Weil, Basic Number Theory, Grundlehren der mathematischen Wissenschaften, Bd. 144, Springer 1985”, is used to obtain a statistically solid estimation of the aforementioned mathematical characterisation.

### CROSS REFERENCE TO RELATED APPLICATIONS

This application is the U.S. National Stage of International Application No. PCT/EP03/03930, filed Apr. 15, 2003 and claims the benefit thereof. The International Application claims the benefits of European application No. 02008552.8 filed Apr. 16, 2002, both of the applications are incorporated by reference herein in their entirety.

### FIELD OF INVENTION

The invention relates to a method for testing and prequalifying subscriber access lines for broadband services.

### BACKGROUND OF INVENTION

Broadband data transmission over the copper wire pairs of the subscriber access lines of the conventional telephone network, in particular ADSL (asymmetrical digital subscriber line), is increasingly gaining in importance. The common characteristic of all standardized XDSL services (ADSL, SDSL, SHDSL, VDSL) is the extension of the frequency range used away from the voice bandwidth (4 kHz) into regions above 1 MHz.

As the telephone network is not designed for this frequency range, these services are based on the rate adaptivity of the transmission methods, i.e. the achievable user data rate depends on the technical/physical conditions of the individual subscriber line.

The main influencing factors here are the line length, the line type and possibly electromagnetically induced interference; however, piecemeal installations, non-professional premises cabling, defective terminals, open spur lines and crosstalk, if numerous xDSL services are offered in a cable unit, also reduce the possible data rates.

For the provider of the services, the unpredictable performance (data rate) of the broadband services means a high first installation risk, if, for example, in installing a line of this kind, the provider incurs financial expenditures which he intends to earn via Internet usage charges (free PC with ADSL modem).

However, even with less risky business models, an estimate of the possible data rate of a broadband service can in any case reduce service costs or improve general customer acceptance of XDSL technology.

Known test methods for subscriber access lines such as time domain reflectometry (TDR for short) for unilateral, measurement-based testing of communication cables have been developed for the voice bandwidth and are therefore only suitable to a limited extent for prequalification for xDSL services.

With TDR measurements, a short (and therefore relatively wideband) voltage pulse is applied to the wire pair and the echo delay is measured. If the propagation rate of the signal is known, the cable length can be directly determined therefrom. By periodic repetition of the measurement and oscilloscopy, even piecemeal installations, open spur lines and similar data rate influencing noise sources can be detected by skilled experts. This method requires the use of well-trained personnel and is therefore complex and costly.

### SUMMARY OF INVENTION

The object of the invention is therefore to specify a method which permits prequalification of a subscriber access line for broadband services and therefore allows the achievable data rate of a broadband service to be accurately predicted with minimal cost/complexity, its essential feature being that it permits the method of measuring the subscriber access lines unilaterally from the exchange.

This object is achieved by the claims.

### DETAILED DESCRIPTION OF INVENTION

The invention will be explained in more detail with reference to an example:

The essence of the method according to the invention is a system identification algorithm by means of which, by applying a signal to the subscriber access line under test, a mathematical characterization of the physical behavior of the subscriber access line is obtained by observing the output signal.

On the basis of this mathematical characterization, the relevant parameters of the subscriber access line are inferred using conventional physical models.

For a statistically robust estimation of said mathematical characterization, a combined time/frequency notation is used, called the Weil transformation according to “A. Weil, Basic Number Theory, Grundlehren der mathematischen Wissenschaften, Vol.144, Springer 1985”.

The method according to the invention will now be described in detail:

A time-discrete multicarrier random signal of the following form is sent out as the test signal:

$$s ( n ) = {\sum }_{k = 0}^{M} {\sum }_{l = 0}^{N} {c}_{k , l} g ( n - {lN}_{T} ) exp ( j2 π \frac{nk}{{M}_{F}} )$$

with the following variables:
n . . . time index (corresponds to the transmit clock)
s(n) . . . sampling values of test signal (in transmit clock)
k . . . symbol index (corresponds to the symbol clock)
l . . . carrier index (corresponds to carrier frequency spacing)
c_{k,j} . . . complex value random coefficients
N_{T} . . . symbol duration (measured in transmit signal clock)
M_{F} . . . length of discrete Fourier transformation on which modulation is based=(#modulation carrier+1)*2−1
g(n) . . . (real value) sampling values of transmit pulse (in transmit clock)

The stochastic innovation of the transmit signal derives exclusively from the complex-valued random coefficients c_{k,j}, the following statistic being aimed for:

$$E \{ {c}_{k , l} {\overline{c}}_{m , n} \} = {σ}^{2} ( k ) {δ}_{k , m} {δ}_{l , n} . \qquad ( 2 )$$

i.e. the coefficients are uncorrelated and their variance depends solely on the carrier index (δ_{k,m} being the Kronecker delta symbol, and \overline{c}_{m,n} the complex conjugate number of c_{m,n}).

Another quite normal condition in the context of baseband multicarrier modulation is the Hermitian symmetry of the coefficients:
c_{k,j}=\overline{c}_{M}_{_{T}}_{-k,j}, (3)

This ensures that the transmit signal is real-valued. Eq. (2) can be obtained to an approximation by a normal pseudorandom number generator (as, for example, in W. H. Press, B. P. Flannery, S. A. Teukolsky, W. T. Vetterling, “Numerical Recipes in C”, Cambridge University Press, Cambridge 1993.) and appropriate weighting.

Provided that the period of the pseudorandom generator is larger than the measurement period, the transmit signal can be regarded as the realization of the cyclostationary random process. This means that, in contrast to conventional time domain reflectometry, the signal is not strictly periodic (there is periodicity only in its statistical characteristics).

Nor, on the other hand, is the test signal a special case of normal multicarrier signals (as used in the training phase of ADSL modems) which use either the cyclical prefix or orthogonal pulseshapes as described in S. D. Sandberg and M. A. Tzannes, “Overlapped discrete multitone modulation for high speed copper wire”, IEEE Journal Selected Areas of Communications, Vol.13, No. 9, December 1995.

The characteristic feature of the invention is the use of a relatively long (spanning 3-5 times the symbol length), well frequency-localized window function, together with the condition
M_{F}=KN_{T}, (5)
so that a non-orthogonal, superabundant system of functions is finally produced.

This is different from the approach of W. Kozek and A. F. Molisch, “Nonorthogonal pulseshapes for multicarrier communications in doubly dispersive channels”, October 1998, IEEE J. Select. Areas Comm., Vol.16, No. 8, pp. 1579-1589 in which a non-orthogonal but incomplete system of functions for multicarrier transmission is proposed.

This means in particular that the redundancy of the transmit signal is to a certain extent spread over time and frequency direction. Such systems of functions are only known from signal analysis, and their use for synthesizing a partially redundant pseudorandom signal is indeed new and inventive. This transmit signal according to the invention offers the following advantages:

The measurement bandwidth can be flexibly organized, i.e. for example the POTS bands (that is to say, the frequency range required for conventional telephony) can be masked out (necessary for integration in the broadband access multiplexer for ADSL). This is a clear advantage over W. W. Jones, “Sequence Time Domain Reflectometry (STDR) For Digital Subscriber Line Provisioning and Diagnostics”, White Paper, Mindspeed Technologies™, where a frequency range beginning from the DC voltage is used.

The available measurement bandwidth can be much better utilized. The sensitivity to impulsive noise is lower. In the case of not strictly synchronous transmit and receive signal sampling, the frequency offset can be explicitly compensated.

By means of phase averaging, the cyclostationary process can be mapped to a stationary process. The power density spectrum Sₛ(f) of the phase-averaged test signal depends on the power distribution on the carriers (defined by σ(k)) and the selection of the pulse g(n):

$${S}_{s} ( f ) = {\sum }_{k = 0}^{{M}_{F} - 1} {σ}^{2} ( k ) {\vert G ( f - \frac{1}{T} ( k - \frac{{M}_{F} - 1}{2} ) ) \vert}^{2} \qquad ( 6 )$$

where T is the sampling period of the transmit signal and G(f) the spectrum of the transmit pulse. By appropriately selecting σ(k), the permissible masks for the transmit spectrum can be achieved e.g. for masking out the POTS bands. The selection of the pulse g(n) is less critical, in the simplest case a conventional, well frequency-localized window function is selected, such as Hamming or Kaiser, see W. Kozek and A. F. Molisch, “Nonorthogonal pulseshapes for multicarrier communications in doubly dispersive channels”, October 1998, IEEE J. Select. Areas Comm., Vol.16, No. 8, pp. 1579-1589. Page 126.

Sections of length N from the transmit signal will now be considered as follows:
sₘ(n)=s(n−mKN_{T})χ_{[0,KN}_{_{T}}_{]}(n−mKN_{T}), (7)
where χ_{[0,N]}(n) stands for a rectangular pulse with amplitude 1 and length N.

The Weil transformation of a vector x(n) of length N=KN_{T} is given by

$${W}_{x} ( n , k ) = \frac{1}{\sqrt{K}} {\sum }_{l = 0}^{K} x ( n + l {N}_{T} ) exp ( j2 π \frac{lk}{L} ) . \qquad ( 8 )$$

it is in one-to-one correspondence with the signal (A. Weil, Basic Number Theory, Grundlehren der mathematischen Wissenschaften, Vol. 144, Springer 1985). Physically m can be interpreted here as the time index and k as the frequency index. The basic principle of the identification method is now to arrive at an estimation of the Weil-transformed echo pulse response via a cross-correlation analysis in the Weil range. The cross-correlation function is defined here as:
C_{y,s}(m,k)=E{W_{y}(n+m,k)\overline{W_{S}(n,k)}}. (9)

Advantageously the Weil transform of a transmit signal block can be formed by two-dimensional, discrete Fourier transformation of the transmit coefficients and multiplication with the Weil transform of the transmit signal window

$${W}_{x χ [ i , i + {KN}_{T} ]} ( m , n ) = {W}_{g} ( m , n ) . {\sum }_{m = 0}^{{N}_{T}} {\sum }_{l = i}^{i + K - 1} {c}_{k , l} exp ( - j2 π ( \frac{mk}{{N}_{T}} + \frac{nl}{K} ) ) \qquad ( 10 )$$

In addition, receive signal coefficients are formed by a scalar product with the modulated receive signal window as follows:

$${d}_{k , l} = {\sum }_{n = l {N}_{T}}^{( l + 1 ) {N}_{T}} y ( n ) γ ( n - l {N}_{T} ) exp ( - j2 π \frac{nk}{{M}_{F}} )$$

From this, the Weil transform of the receive signal y(n) can be formed similarly to (10):

$${W}_{y χ [ i , i + {KN}_{T} ]} ( m , n ) = {W}_{γ} ( m , n ) {\sum }_{m = 0}^{{N}_{T}} {\sum }_{l = i}^{i + K - 1} {d}_{k , l} exp ( - j2 π ( \frac{mk}{{N}_{T}} + \frac{nl}{K} ) )$$

Assuming ergodicity of the input signal (only justified if the period of the pseudorandom signals involved is greater than the measurement time), expectation value formation can be replaced by time/frequency averaging:

$${\tilde{C}}_{y , s} ( m , k ) = \frac{1}{{N}_{M} {K}_{L}} {\sum }_{n = 0}^{{N}_{M}} {W}_{y} ( n , k ) \overline{{W}_{{s}_{m}} ( n + m , k )} , \qquad ( 11 )$$

where sₘ(n) describes the transmit signal block described in Eq. (7).

The proposed method for system identification is of course also suitable for adaptive echo suppression (echo canceling) with the above-described advantages of the possibility of masking out certain frequency bands, as described, for example, in one of the following references:
K. Townsend et al, “Apparatus and method for echo characterization of a communication channel”, U.S. Pat. No. 5,577,116, November 1996.
J. P. Agrawal et al, “Adaptive echo cancellation and equalization system signal processor and method therefor”, U.S. Pat. No. 4,760,596, July 1988.
S. Wu et al, “Efficient echo cancellation for DMT MDSL”, U.S. Pat. No. 6,072,782, June 2000.
M. Ho et al, “Method and apparatus for echo cancellation with discrete multitone modulation”, U.S. Pat. No. 5,317,596, May 1994.

The system identification methods described (as part of an adaptive echo canceller) differ in many respects from the method according to the invention, in most cases modifications of the so-called LMS algorithm are used or the classical Kalman filter.

According to the present application for prequalification of subscriber access lines for broadband services, evaluation of the Weil transform of the pulse response of interest is performed as follows:

Although a practiced observer can already draw conclusions about the length of a line or the type of termination from raw data (e.g. the echo pulse response), for using the present invention an automated evaluation is provided, the end result thereof being the prediction of xDSL performance (“reach prediction”).

Any additive noise relevant in some circumstances for determining xDSL performance can be formed directly from the receive signal coefficients already determined anyway by expected value formation via the time index:

$${S}_{noise , k} = {E}_{l} \{ {\vert {d}_{l , k} \vert}^{2} \}$$

The approach selected now consists in creating a multidimensional table from measured raw data (complex numbers) which is parameterized by relevant physical variables (e.g. line length and termination).

Although the approach will now be described for the parameters line length and termination, evaluation could also similarly be applied to other intermediate parameters.

The raw data \tilde{W}ₕ(p,q) is compared with values of measured reference lines represented as table vectors T^{(k,m)}(p,q) and the indices having the smallest absolute deviation (in the sense of complex numbers) are selected:

$$( {k}_{opt} , {l}_{opt} ) = {arg min}_{k , l} {\sum }_{q}^{} {\sum }_{q}^{} \vert {T}^{( k , l )} ( p , q ) - {\tilde{W}}_{h} ( p , q ) \vert$$

From this comparison, conclusions about the physical characteristics of the subscriber access line under test can therefore be drawn directly.

The index k of the exemplary implementation consequently corresponds to a resistance value of the termination and the index 1 to a line length. In order to increase the resolution of the measurement method, it has been found advantageous to follow this optimization with a complex interpolation. This can be performed using the normal methods for multidimensional interpolation, as described in W. H. Press, B. P. Flannery, S. A. Teukolsky, W. T. Vetterling, “Numerical Recipes in C”, Cambridge University Press, Cambridge 1993.

The xDSL parameters ultimately of interest (data transmission rate to be expected) can then be obtained by a simple table search.

Calibration of the measurement system is advisable if, e.g. in the case of long line lengths, the internal echo of the test setup will typically be much stronger than the characteristic echo from the end of the cable. In the exemplary embodiment, automatic calibration can be performed by connecting digitally controllable line simulators or resistance decades.

1. (canceled)

2. A method for testing and prequalification of subscriber access lines for broadband services comprising the following steps:
applying a time-discrete multicarrier transmit signal formed in accordance with
$$s ( n ) = {\sum }_{k = 0}^{M} {\sum }_{l = 0}^{N} {c}_{k , l} g ( n - {lN}_{T} ) exp ( j2π \frac{nk}{{M}_{F}} )$$
to a test point of a subscriber access line;
measuring the echo pulse response y(n) of the subscriber access line at the test point;
determining second complex-valued random coefficients d_{k,l} from the echo pulse response according to
$${d}_{k , l} = {\sum }_{n = ( l - 1 ) {N}_{T}}^{n = ( l + 1 ) {N}_{T}} y ( n ) γ ( n - {lN}_{T} ) exp ( - j2π \frac{nk}{{M}_{F}} ) ,$$
wherein
an empirical estimate of the cross-correlation function \tilde{W}ₕ(p,q) of the signals formed from the indices c_{k,l} and d_{k,l} by two-dimensional discrete Fourier transformation
$${C}_{m , n}^{( i )} = {\sum }_{m = 0}^{{N}_{T}} {\sum }_{l = i}^{i + K - 1} {c}_{k , l} exp ( - j2π ( \frac{mk}{{N}_{T}} + \frac{nl}{K} ) )$$
$${D}_{m , n}^{( i )} = {\sum }_{m = 0}^{{N}_{T}} {\sum }_{l = i}^{i + K - 1} {d}_{k , l} exp ( - j2π ( \frac{mk}{{N}_{T}} + \frac{nl}{K} ) )$$
is determined according to
$${K}_{m , k}^{( i + 1 )} = ( 1 - λ ) {K}_{m , k}^{( i )} + λ {C}_{m + n , k}^{( i )} {W}_{g} ( m + n , k ) {\overline{D}}_{m , n}^{( i )} {\overline{W}}_{γ} ( m , k )$$
(where 0<λ<1 is a forgetting factor which must be selected according to the entire averaging length of the measurement depending on the computing accuracy of the processor used);
performing according to the estimation of the cross-correlation function, an estimation of the power density spectrum of any noise signals according to
$${S}_{noise , k}^{( i + 1 )} = ( 1 - λ ) {S}_{noise , k}^{( i )} + λ {\vert {d}_{i , k} \vert}^{2} ,$$
comparing the empirical estimate of the cross-correlation function \tilde{W}ₕ(p, q) with the stored values of measured reference lines T^{(k,m)}(p,q); and
determining the physical parameters of the subscriber access line.

3. A method for testing and prequalification of subscriber access lines for broadband services comprising the following steps:
applying a time-discrete multicarrier transmit signal formed in accordance with
$$s ( n ) = {\sum }_{k = 0}^{M} {\sum }_{i = 0}^{N} {c}_{k , i} g ( n - {lN}_{T} ) exp ( j2π \frac{nk}{{M}_{F}} )$$
to a test point of a subscriber access line, wherein
the echo pulse response y(n) of the subscriber access line is measured at the test point, wherein
from the echo pulse response, second complex-valued random coefficients d_{k,l} are determined according to
$${d}_{k , l} = {\sum }_{n = ( l - 1 ) {N}_{T}}^{n = ( l + 1 ) {N}_{T}} y ( n ) γ ( n - {lN}_{T} ) exp ( - j2π \frac{nk}{{M}_{F}} ) ,$$
wherein
the empirical estimate of the cross-correlation function \tilde{W}ₕ(p, q) of the signals formed from the indices c_{k,l} and d_{k,l} by two-dimensional discrete Fourier transformation
$${C}_{m , n}^{( i )} = {\sum }_{m = 0}^{{N}_{T}} {\sum }_{l = i}^{i + K - 1} {c}_{k , l} exp ( - j2π ( \frac{mk}{{N}_{T}} + \frac{nl}{K} ) )$$
$${D}_{m , n}^{( i )} = {\sum }_{m = 0}^{{N}_{T}} {\sum }_{l = i}^{i + K - 1} {d}_{k , l} exp ( - j2π ( \frac{mk}{{N}_{T}} + \frac{nl}{K} ) )$$
is determined according to
$${K}_{m , k}^{( i + 1 )} = ( 1 - λ ) {K}_{m , k}^{( i )} + λ {C}_{m + n , k}^{( i )} {W}_{g} ( m + n , k ) {\overline{D}}_{m , n}^{( i )} {\overline{W}}_{γ} ( m , k )$$
(where 0<λ<1 is a forgetting factor which must be selected according to the entire averaging length of the measurement depending on the computing accuracy of the processor used), and wherein
similarly to the estimation of the cross-correlation function, an estimation of the power density spectrum of any noise signals is performed according to
$${S}_{noise , k}^{( i + 1 )} = ( 1 - λ ) {S}_{noise , k}^{( i )} + λ {\vert {d}_{i , k} \vert}^{2} ,$$
wherein
the empirical estimate of the cross-correlation function \tilde{W}ₕ(p,q) is compared with the stored values of measured reference lines T^{(k,m)}(p,q), and wherein from the comparison, the physical parameters of the subscriber access line are determined.
